(19) United States
(12) Patent Application Publication
(10) Pub. No.: US 2025/0322274 A1
(43) Pub. Date: Oct. 16, 2025

(54) METHOD AND SYSTEM FOR ADAPTIVE GENERATIVE AI VIA FEEDBACK

(71) Applicant: Verizon Patent and Licensing Inc., Basking Ridge, NJ (US)

(72) Inventors: Thiru Voonna, Somerset, NJ (US); Michael D Hanson, Millington, NJ (US); Xuning Tang, Mclean, VA (US); Mohini L Suri, Southlake, TX (US); Diganta K Nayak, Irving, TX (US)

(73) Assignee: Verizon Patent and Licensing Inc., Basking Ridge, NJ (US)

(21) Appl. No.: 18/636,730

(22) Filed: Apr. 16, 2024

(51) Int. Cl. G06N 5/04

(52) U.S. Cl. CPC G06N 5/04

(57) ABSTRACT

The present teaching relates to adaptive generative AI via feedback. Human evaluators evaluate an answer automatically generated by a machine expert in response to a question based on a reference from a source. The evaluation is relied on to update a fidelity metric for each human evaluator. A cumulative ranking of the answer is determined using the evaluation and the updated fidelity metric of each human evaluator. A fidelity attribute for the machine expert is updated based on the cumulative ranking. Feedback is created based on the answer, the question, the cumulative ranking, and the updated fidelity attribute for adapting the performance of the Q&A system.

### CROSS REFERENCE TO RELATED APPLICATION

The present application is related to U.S. patent application Ser. No. ______ (Attorney Docket No.: 146555.589610) filed on Apr. 16, 2024, entitled “METHOD AND SYSTEM FOR QUALITY CONTROL OF ANSWERS AUTOMATICALLY GENERATED VIA GENERATIVE AI”, the contents of which are hereby incorporated by reference in its entirety.

### BACKGROUND

Artificial intelligence (AI) has been utilized to conduct machine-human communications. In recent years, with the development of deep learning capability and the vast amount of available online data, machine-human communications continue to improve with less script-based operations. For example, ChatGPT and the like products can now leverage what is available on different subject matters to carry on conversations to provide what users requested. Such technologies have been adopted by companies/enterprises/businesses to automate, e.g., customer services, enabling communications with customers using generative AI in a cost-effective manner, including question and answer (Q&A) systems.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary AI-based Q&A framework with quality control on answers and adaptivity based on user feedback, in accordance with an embodiment of the present teaching;

FIG. 1B is a flowchart of an exemplary process for an AI-based Q&A framework with quality control on answers and adaptivity based on user feedback, in accordance with an embodiment of the present teaching;

FIG. 1C illustrates exemplary types of feedback information from a user evaluator for adapting an AI-based Q&A system, in accordance with an embodiment of the present teaching;

FIG. 1D depicts an exemplary construct of an AI-based Q&A framework with sub-systems for providing quality answers and performance adaptation, in accordance with an embodiment of the present teaching;

FIG. 2A is a flowchart of an exemplary process for a community-based Q&A system, in accordance with an embodiment of the present teaching;

FIG. 2B is a flowchart of an exemplary process for a feedback-based adaptation system, in accordance with an embodiment of the present teaching;

FIG. 3A depicts an exemplary high level system diagram of an AI-based answer generator, in accordance with an embodiment of the present teaching;

FIG. 3B is a flowchart of an exemplary process for an AI-based answer generator, in accordance with an embodiment of the present teaching;

FIG. 3C shows exemplary types of information collected in a Q&A evaluation database for adaptation, in accordance with an embodiment of the present teaching;

FIG. 3D provides an exemplary tuple in a Q&A evaluation database, in accordance with an embodiment of the present teaching;

FIG. 4A depicts an exemplary high level system diagram of a candidate answer generation engine, in accordance with an embodiment of the present teaching;

FIG. 4B is a flowchart of an exemplary process for generating candidate answers in response to a question, in accordance with an embodiment of the present teaching;

FIG. 4C is a flowchart of an exemplary process for adapting answer generation based on feedback information associated with past Q&As, in accordance with an embodiment of the present teaching;

FIG. 5A illustrates an exemplary node-based construct of a Q&A generator, in accordance with an embodiment of the present teaching;

FIG. 5B shows an exemplary internal construct of an expert node in a community-based Q&A system, in accordance with an embodiment of the present teaching;

FIG. 5C is a flowchart of an exemplary process for an expert node to generate an answer in response to a question based on a reference from a reliable source, in accordance with an embodiment of the present teaching;

FIG. 6A depicts an exemplary high level system diagram of an ML-based answer evaluator, in accordance with an embodiment of the present teaching;

FIG. 6B illustrates exemplary criteria in assessing an answer generated by a machine expert based on a reference, in accordance with an embodiment of the present teaching;

FIG. 6C is a flowchart of an exemplary process for an ML-based answer evaluator, in accordance with an embodiment of the present teaching;

FIG. 7A depicts an exemplary high level system diagram of a feedback-based performance determiner, in accordance with an embodiment of the present teaching;

FIG. 7B is a flowchart of an exemplary process for a feedback-based performance determiner, in accordance with an embodiment of the present teaching;

FIG. 8 is an illustrative diagram of an exemplary mobile device architecture that may be used to realize a specialized system implementing the present teaching in accordance with various embodiments; and

FIG. 9 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching is directed to an AI-based Q&A framework with quality control on answers generated by AI-based machine experts via generative AI as well as the ability of adapting the Q&A performance on-the-fly based on feedback from human evaluators on machine generated answers. The human evaluators may correspond to users and knowledgeable individuals in certain fields, who are recognized over time to provide feedback that is valued by others. In some embodiments, an AI-based machine expert may generate, in response to a question, an answer based on one or more references accessed from some reliable source(s). For example, Wikipedia may be provided initially as a reliable source for providing references in different categories. That is, for a question associated with subject matter, a Wikipedia reference directed to the subject matter may be accessed and utilized to generate an answer to the question. Given a reference from a reliable source, a language model may be deployed to generate an answer in accordance with the reference. The quality of the answer may depend on the base information included in the reference relied on as well as the performance of a machine expert used to generate the answer (e.g., how well the language model associated with the machine expert captures the essence expressed in the reference). The feedback-based adaptation mechanism of the AI-based Q&A framework according to the present teaching enables adaptive learning of both appropriate references from certain sources and the ability of the machine experts for generating answers based on such references.

In some embodiments, with respect to a question, multiple candidate answers may be generated by different machine experts based on respective references from different sources. The quality of each candidate answer may be assessed according to some criteria, and a best candidate answer may be selected as the answer to respond to the question. In some embodiments, the criteria used to evaluate each candidate answer may be application dependent, which may include, e.g., its relevance to the question, its fidelity to the reference relied upon, and the accuracy in its expression. Such quality control according to the present teaching improves the current ChatGPT-like products because the AI-based Q&A framework as disclosed herein is capable of preventing an answer that is either not adequately relevant to the question asked or not accurately expressed from being provided to a user. Using multiple machine experts (a community) to generate multiple candidate answers for selection may further ensure quality of outcome from generative AI.

The feedback-based adaptive mechanism of the present teaching allows adaptation of machine experts based on evaluation from human evaluators on previously generated answers. Such feedback on machine generated answers may be used to generate supervised training data with ground truth information provided from human evaluators for adapting the machine experts. In some embodiments, such feedback may include, e.g., a ranking on a machine generated answer, and, optionally, an alternative answer as well as an alternative reference relied upon by the alternative answer, and an alternative source from where the alternative reference can be accessed. Through such a feedback information, different aspects of the Q&A operation may be adapted in a manner according to the present teaching. For example, through adaptive learning, machine experts may learn to recognize information (references) sources to rely on in answering questions in different subject matters and the ways to generate answers that may more accurately capture the content in a reference.

Through the feedback mechanism, the machine experts' ability to answer questions in different subject matter areas may be ranked using, e.g., fidelity scores, so that different machine experts may be recommended/selected to answer questions based on their past performances. In this process, some machine experts may become gradually specialized via, e.g., reinforcement learning, to answer questions associated with certain subject matters. Based on the feedback mechanism, the sources used to access references for generating answers may also be adjusted over time because human evaluators may provide new sources for certain types of questions. For example, the initial reliable source may include Wikipedia for all questions. Through the feedback mechanism, questions related to some special subject matters, e.g., advanced physics, more appropriate references from more suitable sources relevant to questions on physics may be learned. For instance, human evaluators may provide alternative sources on advanced physics, such as websites of American Institute of Physics, PhysicsWeb, or Institute of Physics, etc.

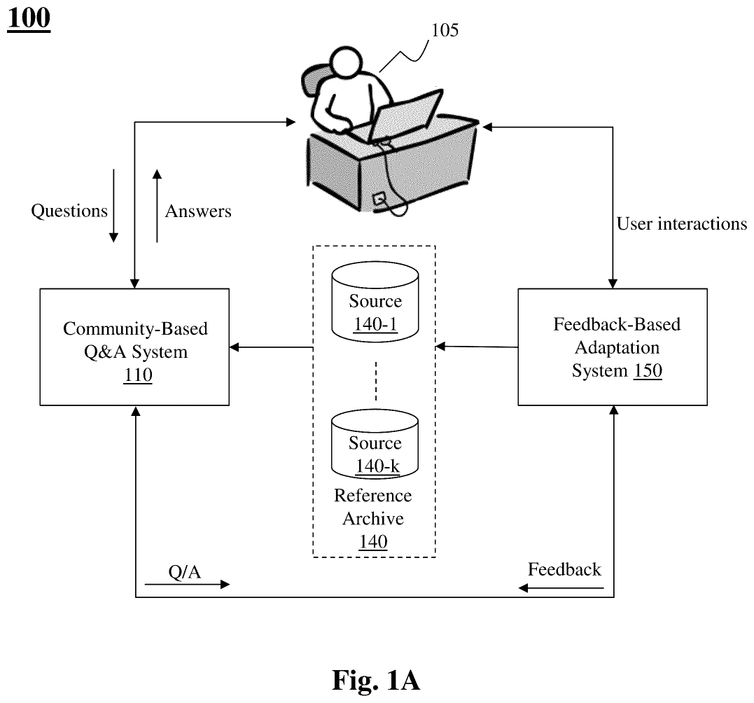

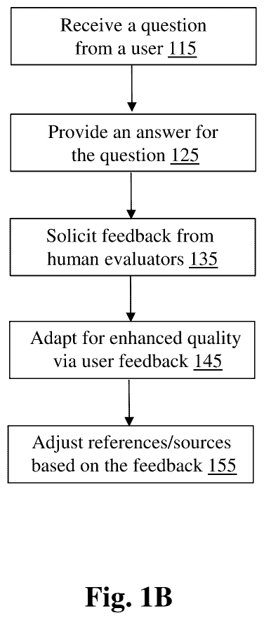

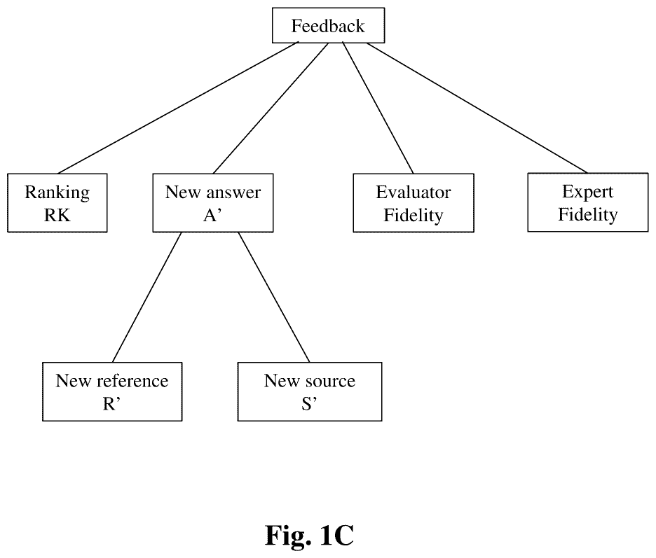

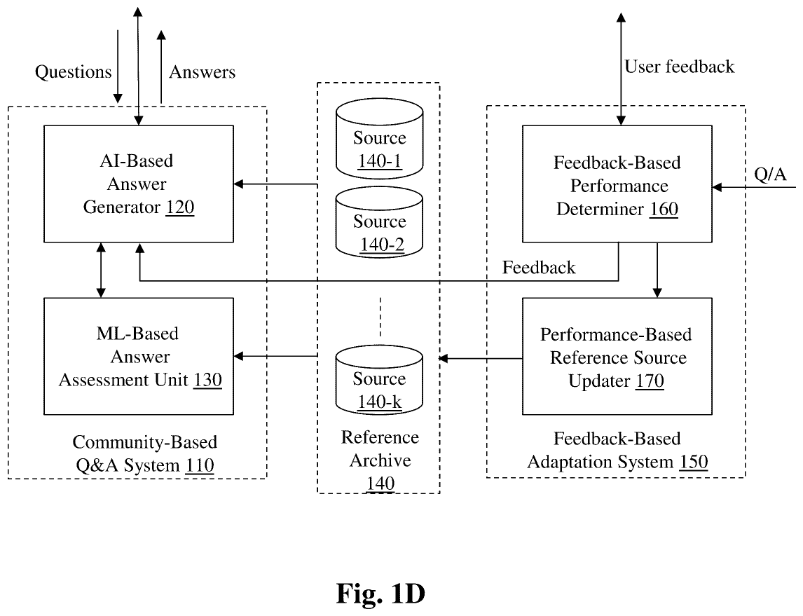

Based on feedback from human evaluators, each answer associated with a question (a Q&A pair) may be characterized with certain attributes including a ranking, which may be determined cumulatively based on the evaluations from different human evaluators. In some embodiments, some Q&A pairs may be cached for quick access, e.g., frequently asked questions with previously generated answers with high rankings, so that answers to such questions may be quickly retrieved from the cache to provide a responsive answer with confidence. In another aspect of the feedback scheme according to the present teaching, each human evaluator may also be evaluated to provide some assessment on trustworthiness of the evaluation from the human evaluator. In some embodiments, the quality of a human evaluator may be measured based on whether others agree with the human evaluator. A fidelity score may be used to represent a level of trustworthiness a human evaluator based on, e.g., the level of affirmation cumulatively expressed by others. Such a fidelity score for a human evaluator may be used to weigh his/her feedback on an answer. Details associated with different aspects of the AI-based Q&A framework according to the present teaching are provided below with reference to FIGS. 1A-7B.

FIG. 1A depicts an exemplary AI-based Q&A framework 100 with quality control on answers and adaptivity based on feedback on answers, in accordance with an embodiment of the present teaching. In this exemplary embodiment, the AI-based Q&A framework 100 includes a user group 105, a community-based Q&A system 110, a reference archive 140, and a feedback-based adaptation system 150. The group 105 may include users who send questions to and receive answers from the community-based Q&A system 110 as well as users who serve as human evaluators who interact with the feedback-based adaptation system 150 to provide feedback on answers generated by the community-based Q&A system 110. As discussed herein, to generate an answer in response to a question from a user, the community-based Q&A system 110 may generate an answer based on a reference accessed from a reliable source archived in 140. Different references in 140 may be associated with different sources, including source 140-1 to source 140-k. The sources and the associated references may change over time and the adjustment may be made in accordance with the feedback on the answers generated.

FIG. 1B is a flowchart of an exemplary process for the 1 AI-based Q&A framework 100, in accordance with an embodiment of the present teaching. When a question is received from a user at 115, the community-based Q&A system 110 provides, at 125, an answer to the user in response to the question. To support adaptation of the framework 100, the feedback-based adaptation system 150 may solicit, at 135, feedback from one or more human evaluators on the answer. The feedback from the human evaluators may then be utilized to adapt, at 145, the community-based Q&A system 110 to achieve enhanced performance and/or to adjust, at 155, the references/sources archived accordingly.

FIG. 1C illustrates exemplary types of feedback information from a human evaluator, in accordance with an embodiment of the present teaching. As illustrated, feedback with respect to each answer generated by the community-based Q&A system 110 may include a ranking RK on an answer A, which may be binary (e.g., thumbs up or thumbs down) or a scale (e.g., one to five, or a preponderance of users agree). Feedback may also include an alternative answer provided by a human evaluator, including, e.g., the new answer A′, an alternative or new reference R′ relied upon to generate A′, or an alternative or new source S′ from where the new reference R′ is accessed. In some situations, such feedback from a human evaluator may be used by the feedback-based adaptation system 150 to determine implied feedback information that is useful for adaptation. For example, rankings on answers may be used to estimate, e.g., the fidelity of the generative AI experts that generated the ranked answers as well as the fidelity of the human evaluators. If an answer from a generative AI expert is ranked high, it corresponds to a higher fidelity of the expert and vice versa. The fidelity attributes associated with different generative AI experts may be used in making recommendations as to which experts are to be used to produce an answer.

Based on feedback information, the fidelity of a human evaluator may also be estimated. For instance, the fidelity of a human evaluator may be determined cumulatively based on whether other evaluators agree or disagree with the specific human evaluator's evaluations of different answers. The higher degree of agreement, the higher the fidelity of the human evaluator and vice versa. Such estimated fidelity for different human evaluators may be utilized to weigh different feedback accordingly to facilitate adaptation. In this way, the feedback information from different human evaluators may be used in a manner that is consistent with the fidelity of such evaluators. As discussed herein, the fidelity of generative AI experts and that for human evaluators may be determined cumulatively over time to reflect their dynamic performance associated therewith.

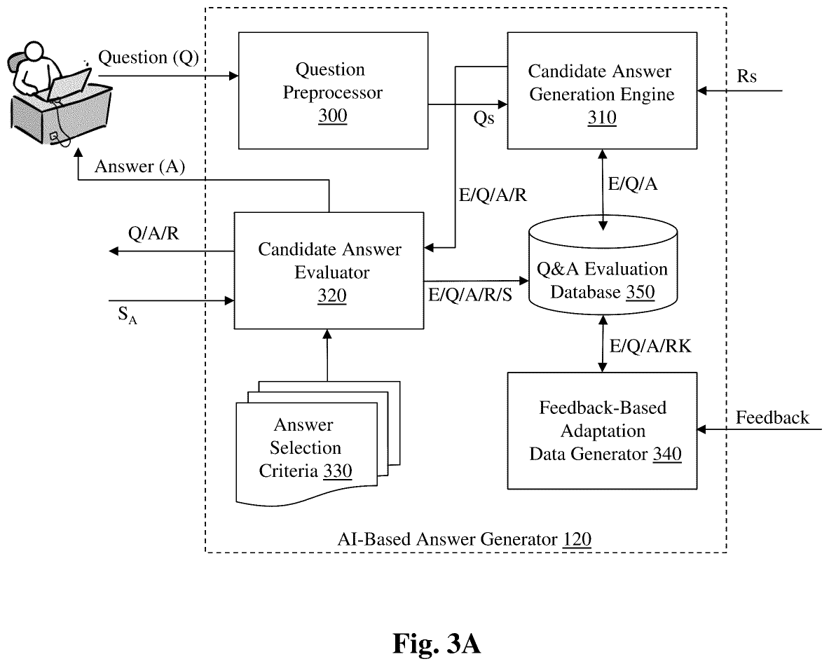

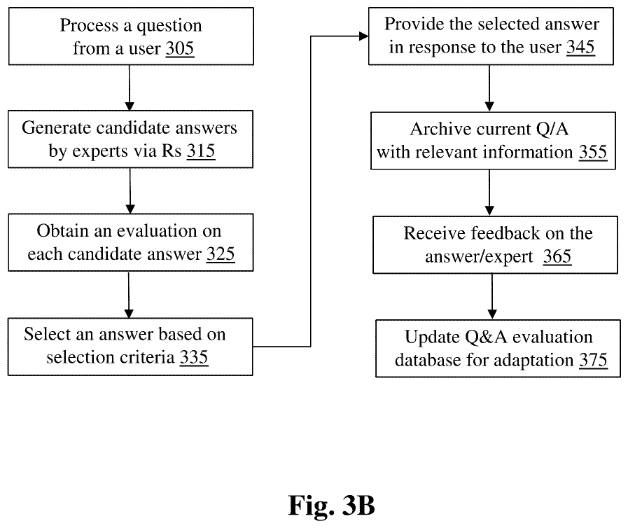

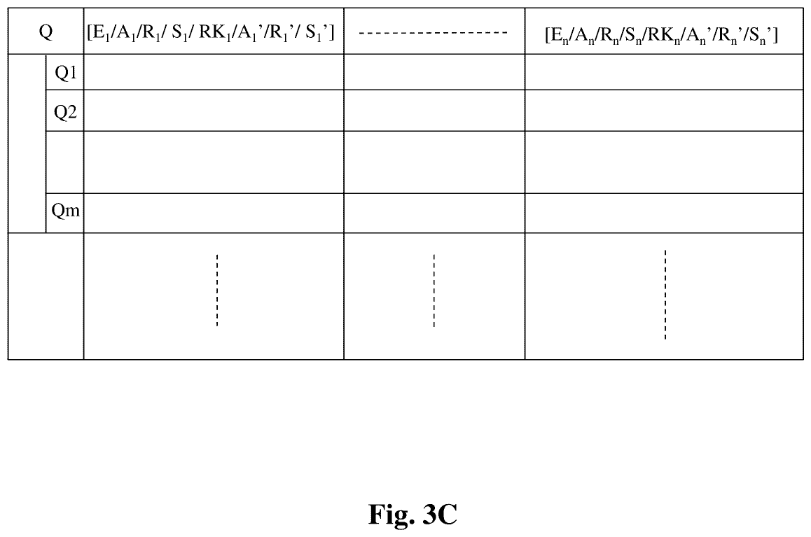

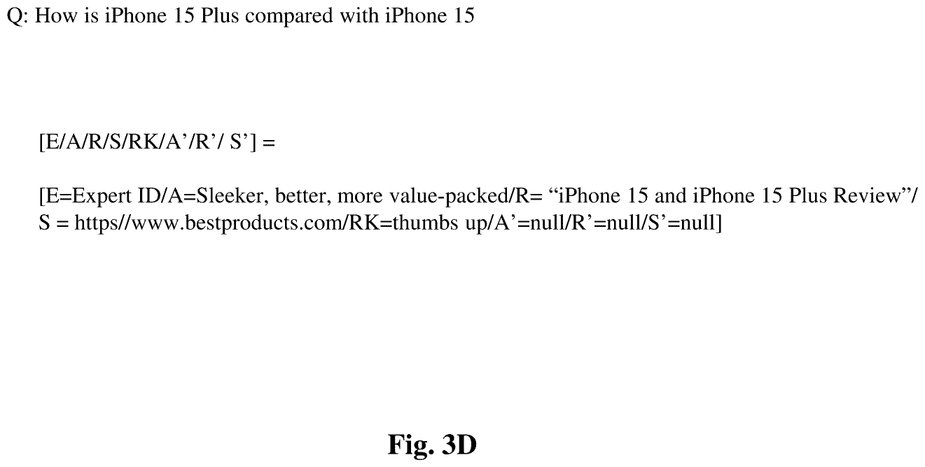

FIG. 1D depicts an exemplary construct of the two sub-systems in the framework 100 for providing quality answers and performance adaptation, in accordance with an embodiment of the present teaching. In this illustrated embodiment, the community-based Q&A system 100 comprises an AI-based answer generator 120 and a machine learning (ML) based answer assessment unit 130. The former may be provided for automatically generating via, e.g., generative AI, candidate answers based on a question and a reference from a reliable source from the reference archive 140. The ML-based answer assessment unit 130 may be provided for providing quality assessment to each of the candidate answers to the AI-based answer generator 120 to enable identification of one of the candidate answers (e.g., the most relevant and accurate) as a response to the question. The AI-based answer generator 120 may adapt over time for enhanced performance based on the feedback received from human evaluators. Details related to the AI-based answer generator 120 and the ML-based answer assessment unit 130 are provided with reference to FIGS. 3A-6C.

In the exemplary embodiment illustrated in FIG. 1D, the feedback-based adaptation system 150 comprises a feedback-based performance determiner 160 and a performance-based reference source updater 170. With respect to the Q&A pairs created via interaction between users and the community-based Q&A system 110, the feedback-based performance determiner 160 may be provided to interface with human evaluators (may be users) to solicit their assessment on answers and, accordingly, generate feedback that may be used by the AI-based answer generator 120 to carry out the adaptation. As shown in FIG. 1C, some feedback content (e.g., ranking, alternative answer/reference/source) may be provided by human evaluators and some may be determined by the feedback-based performance determiner 160 (e.g., the fidelity metrics of different human evaluators) based on feedback information cumulated from different evaluators and users.

In some embodiments, the cumulated information may be used by the performance-based reference source updater 170 to adjust the references from different sources. For instance, initial source for references may be Wikipedia. Over time, according to cumulated feedback information, references used for alternative answers on certain type of questions (e.g., physics) may mostly be from alternative sources (e.g., websites associated with institutions in physics). In this case, the performance-based reference source updater 170 may operate to add more sources and references to the reference archive 140. This may be consistent with the adaptation of the AI-based answer generator 120 to learn more appropriate references/sources based on alternative references from alternative sources provided by human evaluators in order to generate improved answers to such questions.

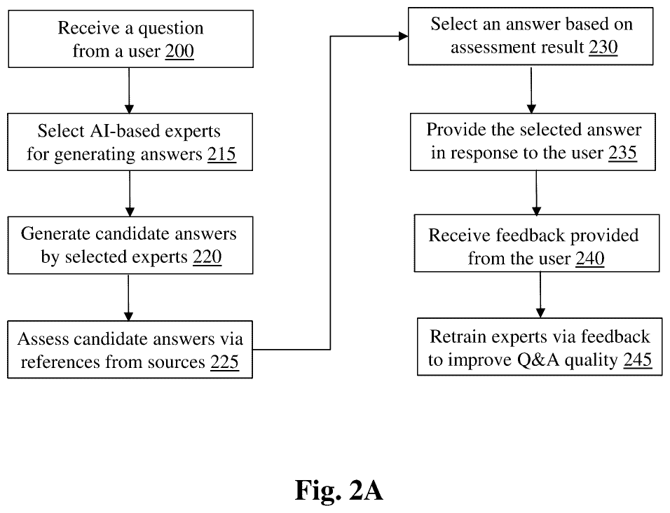

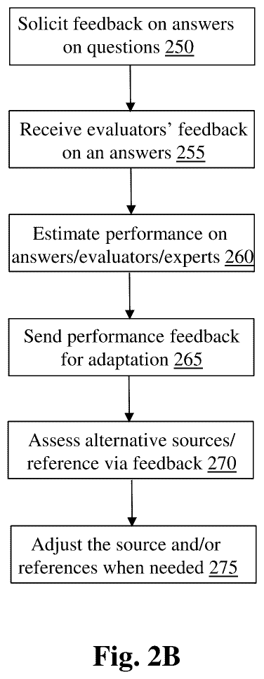

FIG. 2A is a flowchart of an exemplary process for the community-based Q&A system 110, in accordance with an embodiment of the present teaching. When the AI-based answer generator 120 receives, at 200, a question from a user, the generator 120 selects, at 215, some AI-based generative AI experts to generate, at 220, candidate answers to the question. The ML-based answer assessment unit 130 may then assess the quality of each of the candidate answers at 225 and provide the assessment of the candidate answers to the AI-based answer generator 120 to select, at 230, an answer according to the assessment result. As discussed herein, the assessment may be made in terms of, e.g., the relevance of a candidate answers to the question asked, the accuracy of the candidate answer with respect to a reference used to generate it, etc. An answer selected according to the quality assessment may then be provided to the user at 235. As discussed herein, the AI-based answer generator 120 may be adapted based on feedback on answers it generated to improve performance. When the feedback is received, at 240, the AI-based answer generator 120 may re-train, at 245, the generative AI experts based on the received feedback.

FIG. 2B is a flowchart of an exemplary process for the feedback-based adaptation system 150, in accordance with an embodiment of the present teaching. To enable adaptation, the feedback-based performance determiner 160 solicits, at 250, feedback from human evaluators on previously generated answers. When feedback (rankings, new answers, new references, or new sources) is received, at 255, from human evaluators, the feedback-based performance determiner 160 estimates, at 260, cumulatively the performance of each of the answers (cumulative ranking), each of generative AI experts that generated these answers, as well as each of the human evaluators that provided the feedback. Such estimated performance related feedback is then sent, at 265, to the AI-based answer generator 120 for adaptation. For feedback that incorporate new references and/or sources, the performance-based reference source updater 170 may assess, at 270, the need for adjusting the content in the reference archive 140 and if needed, adjust, at 275, information related to the sources and references in the reference archive 140. As discussed herein, such adjustment may be made to be synchronized with the adaptation process so that the adapted AI-based answer generator 120 may operate to access learned useful references from corresponding sources in automatically generating answers to certain questions.

FIG. 3A depicts an exemplary high level system diagram of the AI-based answer generator 120, in accordance with an embodiment of the present teaching. As stated herein, the AI-based answer generator 120 is provided for automatically generating an answer based on generative AI and for adapting itself based on feedback from human evaluators on answers provided previously. With respect to a question from a user, candidate answers may be generated and one of them is selected as the answer to the question based on assessments performed on the candidate answers via the ML-based answer evaluator 130. In this illustrated embodiment, the AI-based answer generator 120 comprises a question preprocessor 300, a candidate answer generator engine 310, a candidate answer evaluator 320, and a feedback-based adaptation data generator 340.

The question preprocessor 300 may be provided for processing the question in a manner that is suitable for further processing. The candidate answer generation engine 310 is provided for generating candidate answers for the question, each of which may then be evaluated and one of the candidate answers may then be selected, in accordance some configured selection criteria 330, by the candidate answer evaluator 320 as a response to the user's question. Information associated with the candidate answers may be stored in a Q&A evaluation database 350 for adaptation. In some embodiment, only information related to the selected answer may be archived for adaptation. When feedback on previously generated answers from human evaluators is received (from the feedback-based performance determiner 160), the feedback-based adaptation data generator 340 is provided for processing the feedback and storing feedback for appropriate answers previously stored therein. The adaptation data stored in the Q&A evaluation database 350 may be utilized by the candidate answer generator engine 310 for adaptation.

FIG. 3B is a flowchart of an exemplary process for the AI-based answer generator 120, in accordance with an embodiment of the present teaching. When a question Q from a user is received, the question preprocessor 300 preprocesses the question at 305. Such preprocessing may include, e.g., identifying entities in the text of the question. The preprocessed question is then used by the candidate answer generation engine 310 with learned machine experts to generate, at 315, candidate answers based on reference(s) (Rs) from reliable source(s). For each candidate answer A, the candidate answer evaluator 320 sends a tuple with Q/A/R to the ML-based answer evaluator 130 and obtains, at 325, an assessment (e.g., one or more scores to evaluate according to different criteria). Based on the assessments to candidate answers, a best candidate answer, determined according to the configured answer selection criteria 330, is selected at 335, and provided, at 345, to the user as a response to the question. Information related to the answer and/or the candidate answers may then be archived, at 355, in the Q&A evaluation database 350. Such relevant information may include the question Q, an answer A (either the answer provided to the user or a candidate answer), the reference R used to generate A and a corresponding resource S, as well as an evaluation score E indicative of the assessment of the quality of the answer.

FIG. 3C shows exemplary construct of content stored in the Q&A evaluation database 350 for adaptation, in accordance with an embodiment of the present teaching. In this example, each question Q may have different versions of asking the same question, i.e., Q1, Q2, . . . , Qm, each of which may correspond to a plurality of tuples, each of which may corresponds to an answer from one of the machine experts. At the time to archive information based on each answer, a tuple may include an answer (may be candidate), a reference R and source S, and an evaluation score to assess the quality of the answer. FIG. 3D illustrates an exemplary entry of such a tuple constructed based on an answer A provided by an expert E to a question Q, a reference R relied on to derive the answer from a source S, a ranking provided by a human evaluator RK, without alternative answer A′, alternative reference R′ from an alternative source S′. The question R involved in this example is “How is iPhone 15 Plus compared with iPhone 15.” With respect to this question, an automatically generated answer A is “Sleeker, better, more value-packed,” which is obtained based on a reference R corresponding to an article entitled “iPhone 15 and iPhone 15 Plus Review” from a source S with IP address “https//www.bestproducts.com.” The ranking RK from a human evaluator is “thumbs up” without providing an alternative answer (A′=null) and an alternative reference (R′=null) from an alternative source (S′=null).

For each of the tuple for an answer archived, whenever feedback is received at 365, the feedback-based adaptation data generator 340 may update, at 375, the previously archived information in database 350. In some embodiments, a tuple previously archived may first be identified with an answer that the received feedback is directed to and then the received feedback is used to supplement the tuple with, e.g., a ranking (RK) on the previously machine generated answer, optionally an alternative answer A′ as well as optional reference R′ from source S′ that are relied on by the alternative answer A′.

The candidate answer generation engine 310 creates not only alternative questions based on a given question, but also candidate answers for each question, and dynamically adapts based on feedback from human evaluators. The rankings to the machine generated answers with optionally alternative answers from human evaluators with alternative references may be used to perform adaptive training of the experts so that the experts may adapt according to the evaluation from the human evaluators over time.

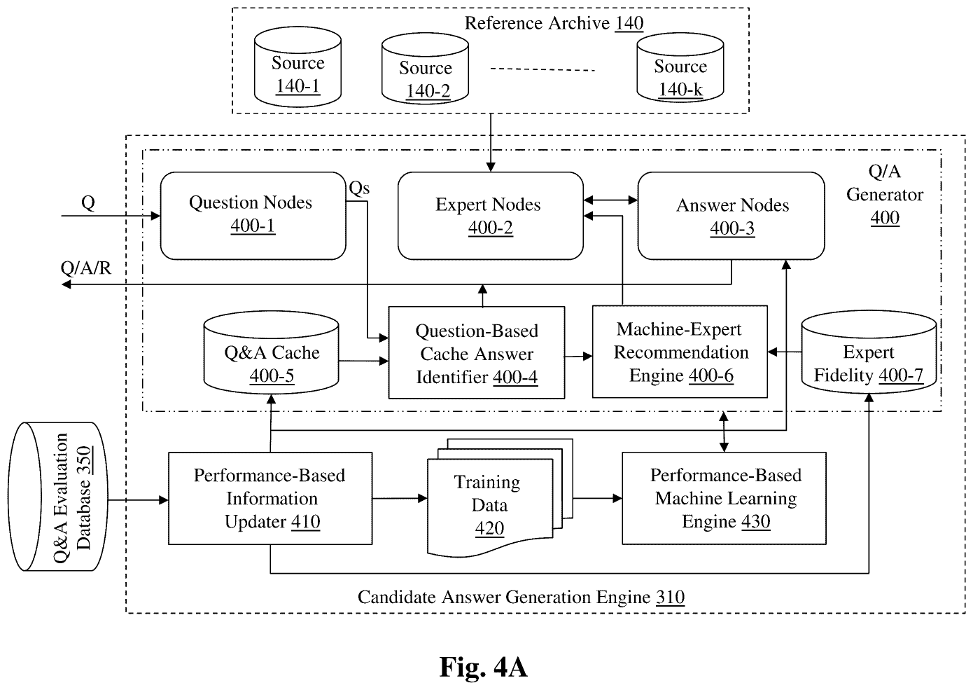

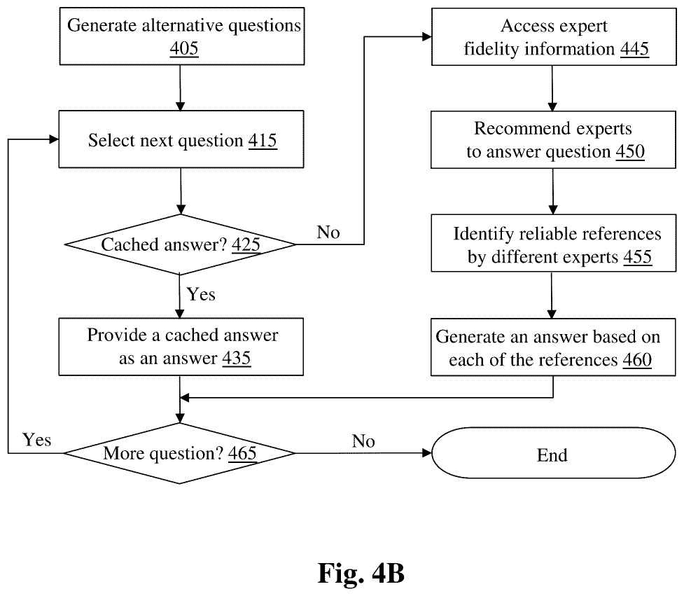

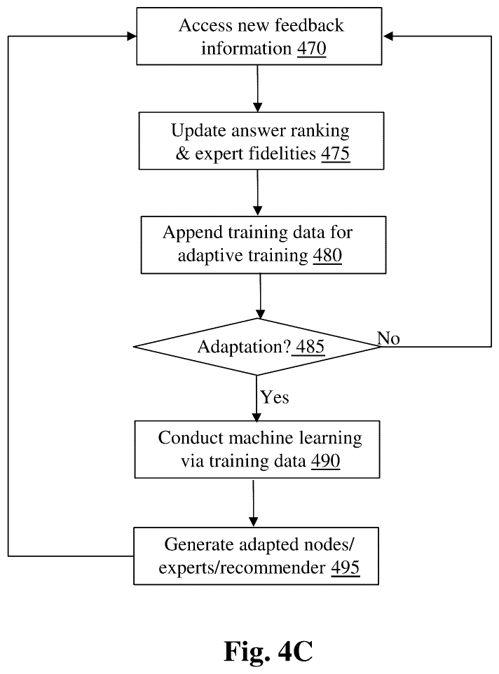

FIG. 4A depicts an exemplary high level system diagram of the candidate answer generation engine 310, in accordance with an embodiment of the present teaching. In this illustrated embodiment, the candidate answer generation engine 310 has two parts, one for producing candidate answers and the other for adaptation based on feedback. The first part is provided herein as Q/A Generator 400 and may be constructed to include a plurality of question nodes 400-1, a plurality of expert nodes 400-2, and a plurality of answer nodes 400-3. The question nodes in 400-1 may be provided for converting a given question to multiple alternative questions, each of which may present the given question differently. The expert nodes 400-4 may be provided as generation units for creating candidate answers based on a given question and such experts may be trained to operate in accordance with generative AI and may be re-trained or adapted dynamically based on new training data created with feedback from human evaluators. The answer nodes in 400-3 may be provided with links to questions (forming Q&A pairs) with attributes (e.g., on its rankings determined, e.g., cumulatively based on feedback. The question/expert/answer nodes may be interconnected with attributes on the links.

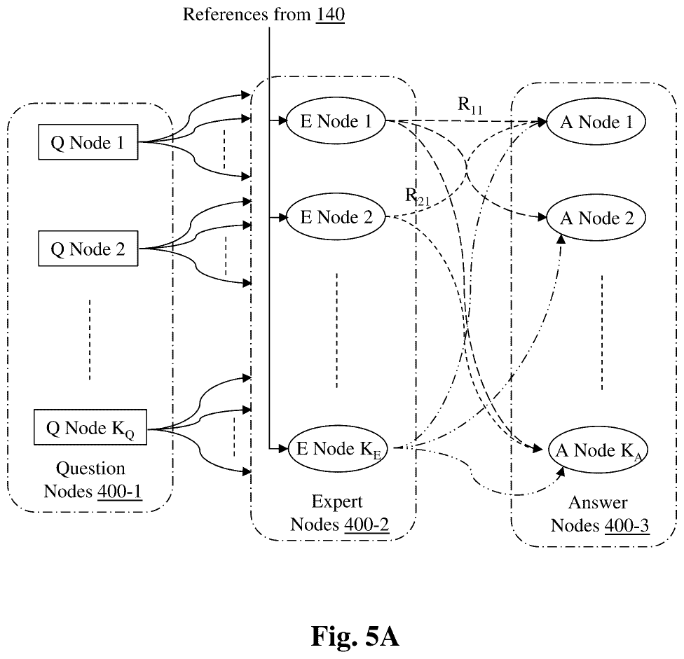

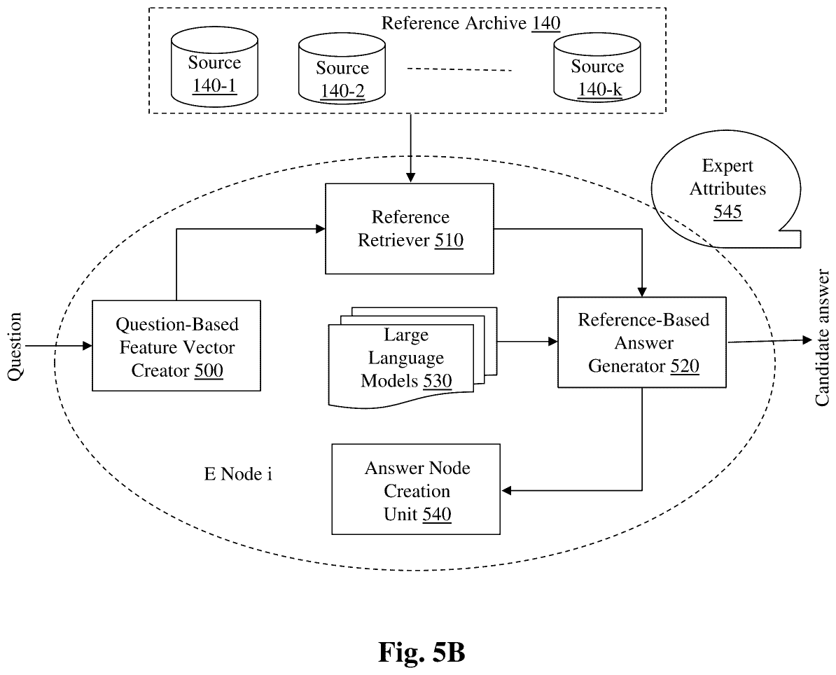

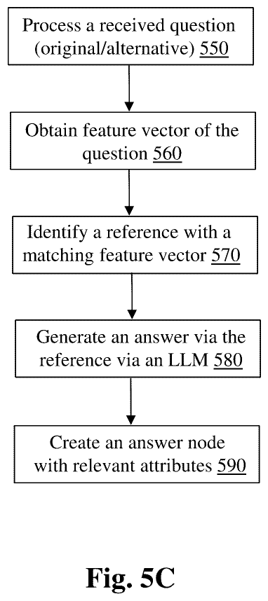

FIG. 5A illustrates exemplary relationships among question/expert/answer nodes, in accordance with an embodiment of the present teaching. In this illustration, each of the question nodes, denoted as Q nodes, may create multiple questions for a given question and each of such alternative questions may be used to generate a candidate answer. Each of the expert nodes, denoted as E nodes, may be invoked to handle one or more questions and generates a candidate answer. In this manner, each of the expert node may be linked to multiple answer nodes, which are denoted as A nodes and store the corresponding answers and the attributes thereof. In some embodiments, each A node may also be associated with attributes characterizing the answer. As discussed herein, each machine expert may be provided to generate a candidate answer for a question based on a reference as determined by the expert from previous training accessed from a reliable source. A link between an expert node and an answer node may be associated with some attributes, including an indication of a reference relied on in generating a candidate answer. From such a construct with interconnected nodes, tuples may be identified, each of which may include a question node representing a question, an expert node representing the machine expert invoked to answer the question, and an answer node representing the answer generated by the linked expert node in response to the question on the linked question node.

Referring to FIG. 4A, the Q/A generator 400 may also comprise a Q&A cache 400-5 for caching Q/As that may be quickly retrieved directly as candidate answers without needing to invoke machine experts to create them. The Q&A pairs to be cached may be determined based on criteria relevant to each application. For instance, Q&As cached may be those that correspond to frequently asked questions with answers that have been ranked high. The question-based cache answer identifier 400-4 may be provided for searching, with respect to a given question, whether there is at least one Q&As cached in the Q&A cache 400-5. If a match is found, the cached answer may be retrieved from the cache 400-5 and output as an answer to the given question. If there is no match, i.e., there is no cached answer for the given question, the machine-expert recommendation engine 400-6 may be invoked to recommend one or more machine experts for generating candidate answers for the given question. In some embodiments, a recommendation as to which machine expert(s) is to generate a candidate answer may be made based on, e.g., the past performance determined cumulatively according to, e.g., feedback from human evaluators on answers previously generated by the machine expert. The performance evaluation on machine experts cumulated may be recorded in an expert fidelity storage 400-7, which may be dynamically updated based on feedback from human evaluators. When recommendations to use certain machine experts to generate answers are made based on such fidelity scores, the machine experts may gradually specialize because positive feedback may create more recommendations and, hence, more adaptation training data so that a reinforcement scenario encourages the machine experts that perform well in certain types of questions continue to improve according to the feedback.

FIG. 4B is a flowchart of an exemplary process for generating candidate answers in response to a question performed by the first part of the candidate answer generation engine, in accordance with an embodiment of the present teaching. As discussed herein, when an input question is received, question nodes may generate, at 405, alternative questions, each of which may be used as an input question for generating candidate answers. For each of such questions, selected at 415, the question-based cache answer identifier 400-4 determines, at 425, whether there is a cached answer. If there is one, then the cached answer is retrieved from the Q&A cache 400-5 and provided as a candidate answer at 435. If there is more question to generate a candidate answer, determined at 465, the process returns to step 415 to handle the next question. If all questions have been handled, the process ends.

If a cached answer for a question does not exist in cache 400-5, determined at 425, the machine-expert recommendation engine 400-6 is invoked for recommending machine expert(s) to generate candidate questions for the question. To do so, the machine-expert recommendation engine 400-6 may access, at 445, information on fidelity of the machine experts from storage 400-7 and accordingly recommend, at 450, one or more machine experts to answer the question. The recommended machine experts may then determine, at 455, respective references from some reliable sources and generate, at 460, their respective candidate answers based on these references. If there is more question to handle, determined at 465, the process returns to step 415 to handle the next question. Otherwise, the process ends with the generated candidate answers.

As shown in FIG. 4A, the second part of the candidate answer generation engine 310 is provided for carrying out the adaptation of the Q/A generator 400 based on information stored in the Q&A evaluation database 350. As discussed herein, information stored in database 350 is recorded when answers to questions are previously generated and when feedback on such answers are received from human evaluators (see FIG. 3C). For this purpose, the second part comprises a performance-based information updater 410, and a performance-based machine learning engine 430. In some embodiments, the former may be provided for creating training data 420 for adaptation training based on information stored in the Q&A evaluation database 350. For example, tuples in databased 350 that include feedback information may be used for adaptation training. Incomplete tuples, e.g., the ones with only information related to previously generated answers without yet feedback information, may not be included in the training data 420 for adaptation. In addition to creating training data 420 for adaptation, the performance-based information updater 410 may also be provided to update evaluation information on, e.g., answers and machine experts. For instance, feedback information from database 350 may be used to update the attributes (e.g., ranking/fidelity scores) associated with relevant answer nodes and/or that of the Q&A pairs stored in cache 400-5. The feedback information may also be used to update the fidelity scores for machine experts in the expert fidelity storage 400-7. Such updates may be carried out in a cumulative manner, i.e., the feedback received may be used to modified existing scores so that both previous and current evaluation may be merged to represent a trend of the evaluation.

FIG. 4C is a flowchart of an exemplary process for the second part for adapting answer generation based on feedback information, in accordance with an embodiment of the present teaching. Whenever there is new feedback information from the Q&A evaluation database 350, the performance-based information updater 410 accesses it at 470 and accordingly updates, at 475, relevant attributes associated with answers (e.g., rankings) and experts (e.g., fidelity scores) nodes as well as the scores associated with, e.g., the cached Q&A pairs. In addition, the newly arrived feedback information may also be used to append, at 480, the training data 420 for adaptation. In some embodiments, the adaptation may be carried out in a predetermined schedule, e.g., either according to a fixed schedule (such as every few weeks) or when the volume of training data 420 reaches an adequate level for a re-training. When adaptation is not yet called for according to a preconfigured condition, determined at 485, the process returns to step 470 to continue to collect new feedback and update nodes attributes and training data 420. When adaptation is needed, the performance-based machine learning engine 430 is invoked to conduct machine learning at 490 based on the feedback-driven training data 420. In some embodiments, the re-training may be carried out to modify learnable parameters employed in constructions of the recommendation engine 400-6, the machine expert nodes 400-2, the question nodes 400-1, the answer nodes 400-3 to minimize some losses (e.g., formulated based on application needs) based on the training data 420. This process generates, at 495, adapted nodes, machine experts, and expert recommendation engine 400-6.

FIG. 5B shows an exemplary internal construct of an expert node (E node i) in the community-based Q&A system 110, in accordance with an embodiment of the present teaching. In this embodiment, each of the machine expert nodes is an independently operable unit which takes a question as an input and generates a candidate answer as output based on at least one reference from a reliable source in the reference archive 140. In this illustrated embodiment, an expert node includes a question-based feature vector creator 500, a reference retriever 510, a reference-based answer generator 520, and an answer node creation unit 540. The question-based feature vector creator 500 is provided for computing a feature vector based on the question to characterize the question to capture its, e.g., semantics. The reference retriever 510 may be provided to use the feature vector representing the question to identify a reference archived in the reference archive 140 that has a feature vector most similar to the feature vector of the question. The reference-based answer generator 520 may be provided to generate, via large language models (LLM) 530, to generate a candidate answer based on the retrieved reference as well as the question.

In some embodiments, the LLMs 530 may be previously trained via machine learning and its parameters may be retrained or adapted. In some embodiments, an answer node for the candidate answer may be created by the answer node creation unit 540 with, e.g., initial attributes which may later be updated according to feedback on the answer. Different modules in an expert node as illustrated in FIG. 5B may be constructed with learnable parameters which may be modified during adaptation training, including the question-based feature vector creator 500, the reference-based answer generator 520, as well as the LLMs 530.

FIG. 5C is a flowchart of an exemplary process for an expert node to create a candidate answer in response to a question based on a reference identified in accordance with an embodiment of the present teaching. When a question is received, it is processed at 550 and a feature vector is obtained, at 560, to represent the question. The feature vector for the question is then used to compare with feature vectors of references to identify, at 570, that is considered match with the question in terms of, e.g., subject matter. Based on the matching reference, the reference-based answer generator 520 generates, at 580, a candidate answer via the LLM 530. An answer node may then be accordingly generated, at 590, with initial relevant attributes.

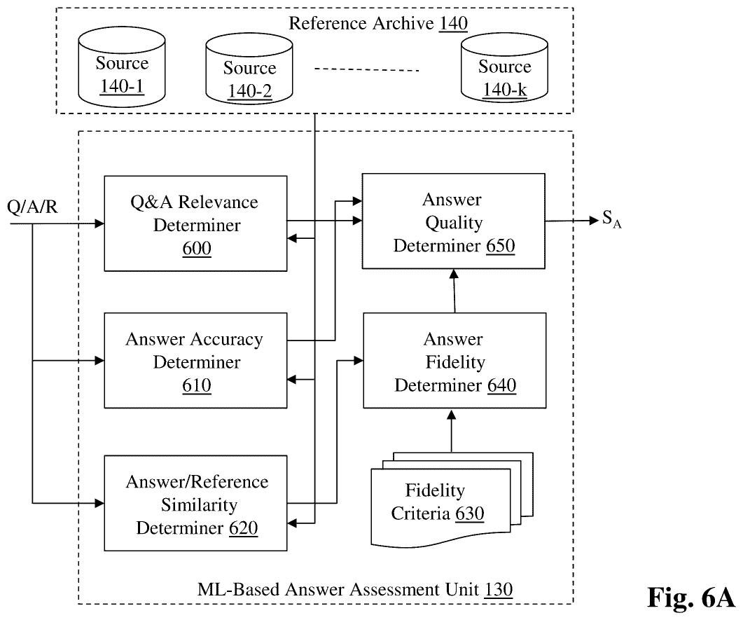

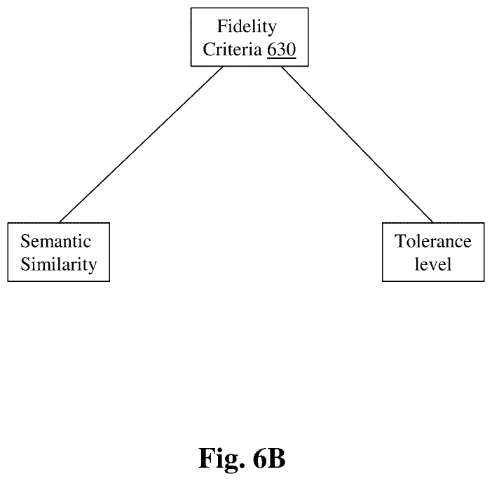

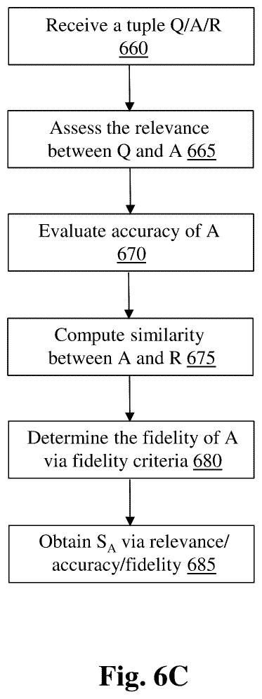

As discussed herein, given a question, each of candidate answers generated by machine experts may be evaluated to ensure to provide a quality answer to the user. It is important as it is known that some content created via generative AI may not be satisfactory. For example, some answers from generative AI may not be responsive to the question asked. Quality control according to the present teaching is provided to prevent such situations. As discussed herein, evaluation of candidate answers is performed by the ML-based answer evaluator 130. FIG. 6A depicts an exemplary high level system diagram of the ML-based answer evaluator 130, in accordance with an embodiment of the present teaching. As provided in FIG. 6A, the ML-based answer evaluator 130 takes a tuple as input including, e.g., a question Q, a candidate answer A, and a reference R used to generate the candidate answer, and product a score SA for the candidate answer representing the quality of the candidate answer. As discussed herein, the quality of an answer may be evaluated based on, e.g., the relevance of the answer A and the question Q, the accuracy of the answer, and the fidelity of the candidate answer, etc.

In this illustrated embodiment, the ML-based answer evaluator 130 comprises a Q&A relevance determiner 600, an answer accuracy determiner 610, an answer/reference similarity determiner 620, an answer fidelity determiner 640, and an answer quality determiner 650. The Q&A relevance determiner 600 may be provided to assess the relevance between the question and the answer. For example, if a question is directed to health, if a candidate answer is instead on music, then the relevance between the question and the candidate answer is low. The answer accuracy determiner 610 may be provided to evaluate whether the candidate answer is adequately accurate linguistically. The answer fidelity determiner 640 may be provided to assess the fidelity of a candidate answer, e.g., whether the candidate answer faithfully captures the semantics of the reference. In some embodiments, the fidelity of a candidate answer may be evaluated in accordance with some predetermined fidelity criteria 630, which may be configured based on application needs.

FIG. 6B illustrates exemplary criteria provided to assess the fidelity of a candidate answer generated by a machine expert based on a reference, in accordance with an embodiment of the present teaching. For example, the fidelity of a candidate answer may be defined according to different criteria. As shown in FIG. 6B, one aspect of the fidelity may be defined based on the semantic similarity between the candidate answer and a reference relied upon for its generation. In this case, the semantic similarity may measure how faithfully the candidate answer captures the semantics of the reference. Another exemplary aspect of an answer's fidelity may be defined based on a level of tolerance that may define what is acceptable when the candidate answer does not quite capture the semantics of the reference. The answer/reference similarity determiner 620 may be provided to compute the semantic similarity between a candidate answer and a reference based on which the candidate answer is generated. A higher similarity measure may indicate that the candidate answer captures the semantics of the reference. The similarity may be characterized based on any measure for representing the affinity of two texts, including a distance measure or a cosine measure computed based on, e.g., two feature vectors obtained respectively from the candidate answer and the reference used to create the candidate answer.

While a candidate answer may have a higher semantic similarity to a reference, it may or may not be true that the candidate answer responds to the question well, which may depend on, e.g., the relevancy of the reference to the question asked. As discussed herein with reference to FIGS. 4A and 5B, identification of an appropriate reference based on a question may be adaptable based on feedback when the feedback provides alternative answers with supporting references. In generating candidate answers, the answer quality determiner 650 assesses the quality based on the outputs from the Q&A relevance determiner 600 (on relevance), the answer accuracy determiner 610 (on accuracy), as well as the answer fidelity determiner 640 (on fidelity). Any other measures needed different applications may be developed and incorporated herein to ensure the quality of machine generated answers to serve as a safeguard to outcome yielded via generative AI. The exemplary metrics disclosed herein are merely for illustration rather than limitation to the scope of the present teaching.

FIG. 6C is a flowchart of an exemplary process for the ML-based answer evaluator 130, in accordance with an embodiment of the present teaching. When a tuple associated with a candidate answer is received (e.g., Q/A/R) at 660, the Q&A relevance determiner 600 assesses, at 665, the relevance between the question R and the candidate answer A. The answer accuracy determiner 610 may also evaluates, at 670, the accuracy of the candidate answer A. The answer/reference similarity determiner 620 computes, at 675, the semantic similarity between A and reference R and provides the computed metric to the answer fidelity determiner 640, which determines, at 680, the fidelity of the candidate answer based on the pre-configured fidelity criteria 630. With the assessments with respect to different aspects of the candidate answer, the answer quality determiner 650 obtains, at 685, a score SA for candidate answer A. As discussed herein, the quality scores for different candidate answers generated by, e.g., multiple machine experts and/or with respect to alternative questions may be utilized by the AI-based answer generator 120 to select a best qualified answer as a response to the question.

Automatically obtaining answers with quality control thereof according to the present teaching improves the current state of generative AI as it detects and minimizes answers that may not be responsive to the questions asked. In addition, as the present teaching supports adaptation of its answer generation mechanism based on feedback from human evaluators, it further enhances a Q&A system's ability of bootstrapping its own performance by leveraging feedback from human evaluators (users or other authoritative people) so that the relevance and accuracy of the generated answers may be dynamically adapted in time to each period of time or in space for different applications. As discussed herein with reference to FIGS. 1A and 1D, the feedback-based adaptation system 150 is provided to facilitate the adaptation, where the feedback-based performance determiner 160 is for soliciting feedback from human evaluators and extracting relevant feedback data therefrom to enable the AI-based answer generator 120 to adapt accordingly. While the performance-based reference source updater 170 may be provided to modify the references/sources archived in 140 based on the alternative references from alternative sources in relation to certain types of questions. This makes it possible to adapt the basis of answer generation with respect to both time (e.g., concepts/views expressed in different references may change over time) and space (e.g., different locales may rely on different references).

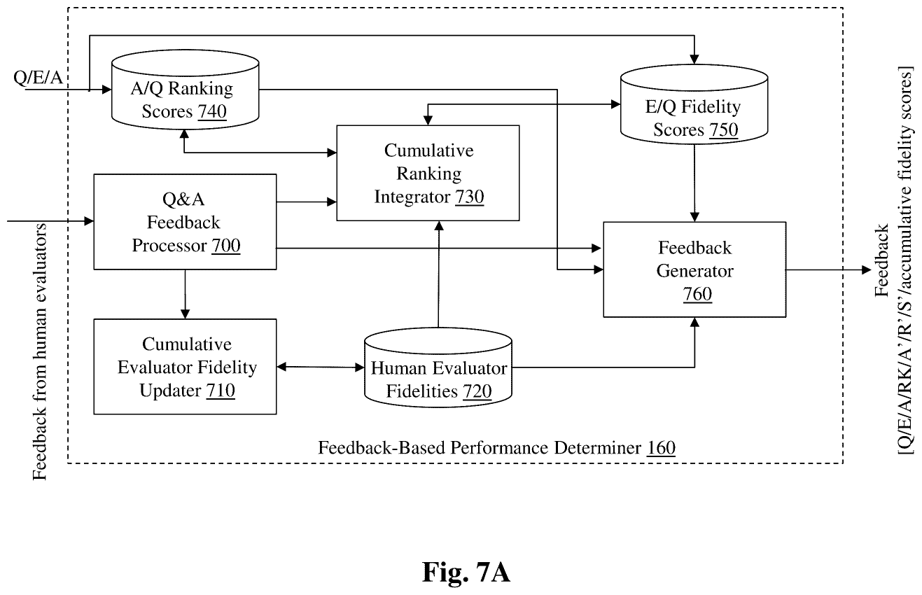

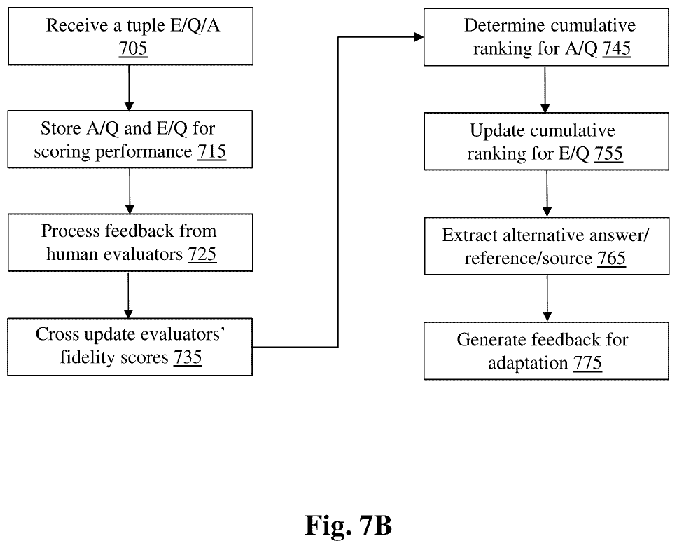

FIG. 7A depicts an exemplary high level system diagram of the feedback-based performance determiner 160, in accordance with an embodiment of the present teaching. To solicit feedback on previously generated answers, the feedback-based performance determiner 160 may receive tuples, each represented as Q/E/A (representing an answer A generated by a machine expert E on a question Q) and output feedback data including a ranking RK on A (cumulative) and different fidelity scores for, e.g., the Q/A pair and Q/E pair, representing, e.g., a cumulative assessment of the machine expert for generating answers for Q type of questions. In this illustrated embodiment, the feedback-based performance determiner 160 comprises a Q&A feedback processor 700, a cumulative evaluator fidelity updater 710, a cumulative ranking integrator 730, and a feedback generator 760.

For a previously generated answer, one or more human evaluators may provide their feedback (e.g., thumbs up or thumbs down or some ranking score on a scale). Such feedback across different human evaluators may be integrated to determine the cumulative feedback. For instance, in some embodiments, feedback from different human evaluators may be averaged. In some embodiments, a best or worst feedback may be used, etc. To evaluate the performance of an answer or a machine expert, the currently received feedback may be used to update an existing performance evaluation (e.g., derived based on past feedback) so that the performance evaluation may also be cumulated across the past and current evaluation. FIG. 7B is a flowchart of an exemplary process for the feedback-based performance determiner 160, in accordance with an embodiment of the present teaching. For each answer A generated by a machine expert E on a question Q, a tuple E/Q/A is received to the feedback-based performance determiner 160 at 705, relevant information is stored at 715. For example, the A/Q pair from the tuple may be stored in a storage 740 for A/Q ranking scores and the E/Q pair may be stored in a storage 750 for E/Q fidelity scores.

When the feedback from human evaluators directed to an answer A generated by a machine expert E on a question Q is received, the Q&A feedback processor 700 processes, at 725, the received information. The cumulative evaluator fidelity updater 710 may cross update, at 735, the fidelity scores of relevant human evaluators stored in a storage 710. For example, if 5 human evaluators provide feedback on A, with four providing thumbs up and one thumbs down, then each of the four human evaluators giving positive feedback may receive a higher fidelity score because there are another three with feedback affirming or agreeing with this human evaluator. The human evaluator giving the negative feedback may receive a low fidelity score because no one agrees with his/her negative feedback. Each of these five human evaluators may already have an existing fidelity score previously determined based on past performance. In this case, the fidelity assessment of each human evaluator when providing feedback on an answer A may be integrated with the previously determined fidelity score to derive a cumulated fidelity score.

Similarly, the cumulative ranking integrator 730 operates to update, cumulatively at 755, the ranking for the A/Q pair (stored in storage 740) and the fidelity score for the E/Q pair (in 750), respectively. In some embodiments, the fidelity scores for the participating human evaluators may be used to weigh the feedback from these human evaluators in order to compute the cumulative ranking and score for the expert. For instance, continuing the previous example, as one of the human evaluator's negative ranking is not affirmed by other four human evaluators (with positive feedback), the weight to the feedback from the negative human evaluator may be set low and the weights of the feedback from the other human evaluators may be set high. Through this mechanism, the cumulative evaluation result is based on the statistics of the overall evaluation. To generate the feedback for adaptation, the feedback generator 760 accesses the tuple, the updated A/Q ranking, and the updated E/Q fidelity score, and extracts, at 765, possible additional information from the feedback (e.g., an alternative answer A′, an alternative reference R′ from an alternative source S′) before it generates, at 775, the adaptation feedback to be provided to the feedback-based adaptation data generator 340 in AI-based answer generator 120 (see FIG. 3A).

The present teaching improves the state of the art as quality control on machine generated answers (via generative AI) can reduce or eliminate answers with quality issue (e.g., not relevant to what is asked, etc.), continuous feedback from users/authoritative personnel on machine generated answers can enable adaptation to bootstrap performance in generating satisfactory answers. In addition, as the feedback mechanism supports the learning and adjustment to references relied upon to generate answers, the knowledge needed to handle different questions may grow and change over time depending on the need of an application. Furthermore, based on the feedback mechanism as discussed herein, the fidelity of not only the answers but also the machine experts that generate such answers may be determined over time, enabling recommendation of suitable machine experts when faced with different questions. Because the fidelity of answers and machine experts may be established in a cumulative manner, the present teaching facilitates specialization of machine experts in answering questions in different categories. As presented herein, the present teaching also discloses to establish the fidelity of human evaluators in a cumulative way through, e.g., cross validation, the performance of human evaluators may also be assessed and accordingly used to determine the weights of their respective feedback when adapting the machine experts. Thus, the AI-based Q&A framework 100 as disclosed herein according to the present teaching represents an ego system that makes it possible to continuous enhancement in any application environment.

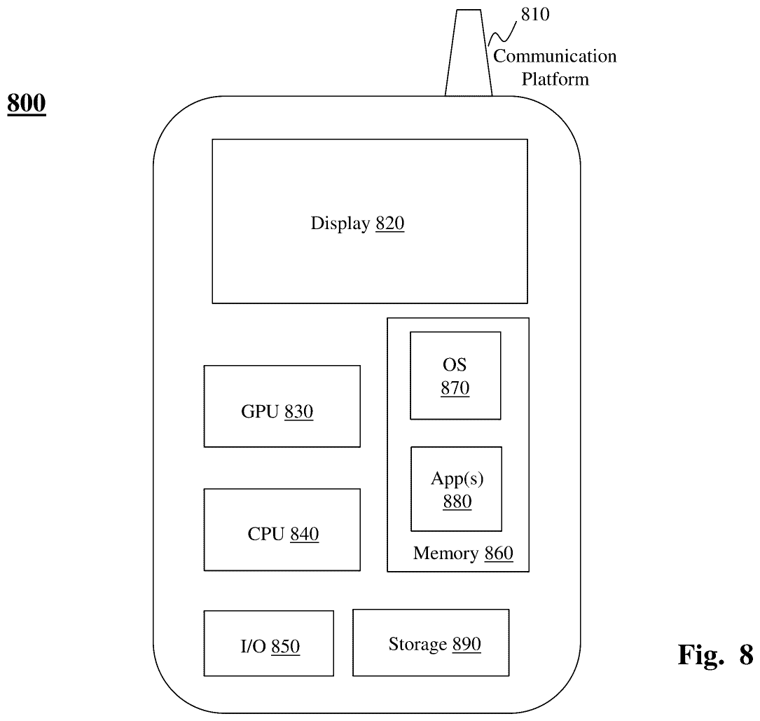

FIG. 8 is an illustrative diagram of an exemplary mobile device architecture that may be used to realize a specialized system implementing the present teaching in accordance with various embodiments. In this example, the user device on which the present teaching may be implemented corresponds to a mobile device 800, including, but not limited to, a smart phone, a tablet, a music player, a handled gaming console, a global positioning system (GPS) receiver, and a wearable computing device, or a mobile computational unit in any other form factor. Mobile device 800 may include one or more central processing units (“CPUs”) 840, one or more graphic processing units (“GPUs”) 830, a display 820, a memory 860, a communication platform 810, such as a wireless communication module, storage 890, and one or more input/output (I/O) devices 850. Any other suitable component, including but not limited to a system bus or a controller (not shown), may also be included in the mobile device 800. As shown in FIG. 8, a mobile operating system 870 (e.g., iOS, Android, Windows Phone, etc.) and one or more applications 880 may be loaded into memory 860 from storage 890 in order to be executed by the CPU 840. The applications 880 may include a user interface or any other suitable mobile apps for information exchange, analytics, and management according to the present teaching on, at least partially, the mobile device 800. User interactions, if any, may be achieved via the I/O devices 850 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

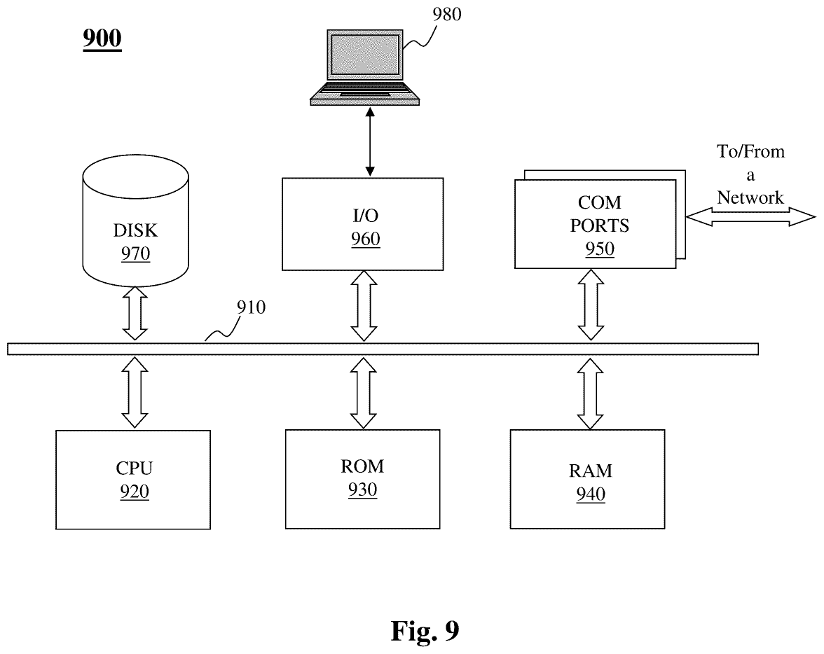

FIG. 9 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 900 may be used to implement any component or aspect of the framework as disclosed herein. For example, the information processing and analytical method and system as disclosed herein may be implemented on a computer such as computer 900, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 900, for example, includes COM ports 950 connected to and from a network connected thereto to facilitate data communications. Computer 900 also includes a central processing unit (CPU) 920, in the form of one or more processors, for executing program instructions. The exemplary computer platform includes an internal communication bus 910, program storage and data storage of different forms (e.g., disk 970, read only memory (ROM) 930, or random-access memory (RAM) 940), for various data files to be processed and/or communicated by computer 900, as well as possibly program instructions to be executed by CPU 920. Computer 900 also includes an I/O component 960, supporting input/output flows between the computer and other components therein such as user interface elements 980. Computer 900 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving, from one or more human evaluators, evaluation directed to an answer automatically generated by a machine expert in a question & answer (Q&A) system in response to a question related to a subject matter based on a reference from a source;
updating a fidelity metric associated with each of the one or more human evaluators based on the evaluation;
determining a cumulative ranking of the answer with respect to the question according to the evaluation and the updated fidelity metric of each of the one or more human evaluators;
updating a fidelity attribute associated with the machine expert based on the cumulative ranking, wherein the fidelity attribute is indicative of an ability of the machine expert in answering questions in the subject matter;
generating feedback based on the answer, the question, the cumulative ranking of the answer with respect to the question, and the updated fidelity attribute of the machine expert; and
sending the feedback to the Q&A system for adapting the Q&A system.

2. The method of claim 1, wherein the Q&A system includes a plurality of machine experts for automatically generating answers to questions, wherein, for each question asked, at least some of the plurality of machine experts are selected for providing an answer to the question and the selection is based, at least partially, on the fidelity attribute associated with each of the plurality of machine experts.

3. The method of claim 1, wherein the updating the fidelity metric of each of the one or more human evaluators comprises:
identifying a ranking for the answer provided by the human evaluator from the evaluation;
determining a number of other rankings from remainder of the one or more human evaluators that are consistent with the ranking;
determining a parameter based on the number of rankings from others; and
updating an existing fidelity metric associated with the human evaluator based on the parameter to generate the updated fidelity metric for the human evaluator.

4. The method of claim 1, wherein the determining a cumulative ranking of the answer comprises:
retrieving an existing ranking for the answer for the question;
accessing the updated fidelity metric for each of the one or more human evaluators;
identifying a ranking from the evaluation from each of the one or more human evaluators;
weighing the ranking of each of the one or more human evaluators based on the updated fidelity metric thereof to generate a weighted ranking for the human evaluator;
obtaining an integrated ranking for the answer based on the weighted ranking of each of the one or more human evaluators; and
determining the cumulative ranking of the answer based on the existing ranking and the integrated ranking for the answer.

5. The method of claim 4, wherein the updating the fidelity attribute of the machine expert comprises:
retrieving an existing fidelity attribute associated with the machine expert;
modifying the existing fidelity attribute based on the cumulative ranking of the answer; and
generating an updated fidelity attribute based on the modified fidelity attribute for the machine expert.

6. The method of claim 1, wherein the feedback further includes at least one of an alternative answer in place of the answer provided by one of the one or more human evaluators, an alternative reference that supports the alternative answer, and an alternative source to access the alternative reference.

7. The method of claim 6, further comprising:
extracting, from the feedback, information related to the alternative reference and the alternative source; and
modifying an archive storing references from different sources based on the alternative reference and the alternative source.

8. A machine readable and non-transitory medium having information recorded thereon, wherein the information, when read by the machine, causes the machine to perform the following steps:
receiving, from one or more human evaluators, evaluation directed to an answer automatically generated by a machine expert in a question & answer (Q&A) system in response to a question related to a subject matter based on a reference from a source;
updating a fidelity metric associated with each of the one or more human evaluators based on the evaluation;
determining a cumulative ranking of the answer with respect to the question according to the evaluation and the updated fidelity metric of each of the one or more human evaluators;
updating a fidelity attribute associated with the machine expert based on the cumulative ranking, wherein the fidelity attribute is indicative of an ability of the machine expert in answering questions in the subject matter;
generating feedback based on the answer, the question, the cumulative ranking of the answer with respect to the question, and the updated fidelity attribute of the machine expert; and
sending the feedback to the Q&A system for adapting the Q&A system.

9. The medium of claim 8, wherein the Q&A system includes a plurality of machine experts for automatically generating answers to questions, wherein, for each question asked, at least some of the plurality of machine experts are selected for providing an answer to the question and the selection is based, at least partially, on the fidelity attribute associated with each of the plurality of machine experts.

10. The medium of claim 8, wherein the updating the fidelity metric of each of the one or more human evaluators comprises:
identifying a ranking for the answer provided by the human evaluator from the evaluation;
determining a number of other rankings from remainder of the one or more human evaluators that are consistent with the ranking;
determining a parameter based on the number of rankings from others; and
updating an existing fidelity metric associated with the human evaluator based on the parameter to generate the updated fidelity metric for the human evaluator.

11. The medium of claim 8, wherein the determining a cumulative ranking of the answer comprises:
retrieving an existing ranking for the answer for the question;
accessing the updated fidelity metric for each of the one or more human evaluators;
identifying a ranking from the evaluation from each of the one or more human evaluators;
weighing the ranking of each of the one or more human evaluators based on the updated fidelity metric thereof to generate a weighted ranking for the human evaluator;
obtaining an integrated ranking for the answer based on the weighted ranking of each of the one or more human evaluators; and
determining the cumulative ranking of the answer based on the existing ranking and the integrated ranking for the answer.

12. The medium of claim 114, wherein the updating the fidelity attribute of the machine expert comprises:
retrieving an existing fidelity attribute associated with the machine expert;
modifying the existing fidelity attribute based on the cumulative ranking of the answer; and
generating an updated fidelity attribute based on the modified fidelity attribute for the machine expert.

13. The medium of claim 8, wherein the feedback further includes at least one of an alternative answer in place of the answer provided by one of the one or more human evaluators, an alternative reference that supports the alternative answer, and an alternative source to access the alternative reference.

14. The medium of claim 13, wherein the information, when read by the machine, further causes the machine to perform the following steps:
extracting, from the feedback, information related to the alternative reference and the alternative source; and
modifying an archive storing references from different sources based on the alternative reference and the alternative source.

15. A system, comprising:
a feedback-based performance determiner implemented using a processor and configured for
receiving, from one or more human evaluators, evaluation directed to an answer automatically generated by a machine expert in a question & answer (Q&A) system in response to a question related to a subject matter based on a reference from a source,
updating a fidelity metric associated with each of the one or more human evaluators based on the evaluation,
determining a cumulative ranking of the answer with respect to the question according to the evaluation and the updated fidelity metric of each of the one or more human evaluators,
updating a fidelity attribute associated with the machine expert based on the cumulative ranking, wherein the fidelity attribute is indicative of an ability of the machine expert in answering questions in the subject matter,
generating feedback based on the answer, the question, the cumulative ranking of the answer with respect to the question, and the updated fidelity attribute of the machine expert, and
sending the feedback to the Q&A system for adapting the Q&A system.

16. The system of claim 15, wherein the Q&A system includes a plurality of machine experts for automatically generating answers to questions, wherein, for each question asked, at least some of the plurality of machine experts are selected for providing an answer to the question and the selection is based, at least partially, on the fidelity attribute associated with each of the plurality of machine experts.

17. The system of claim 15, wherein the updating the fidelity metric of each of the one or more human evaluators comprises:
identifying a ranking for the answer provided by the human evaluator from the evaluation;
determining a number of other rankings from remainder of the one or more human evaluators that are consistent with the ranking;
determining a parameter based on the number of rankings from others; and
updating an existing fidelity metric associated with the human evaluator based on the parameter to generate the updated fidelity metric for the human evaluator.

18. The system of claim 15, wherein the determining a cumulative ranking of the answer comprises:
retrieving an existing ranking for the answer for the question;
accessing the updated fidelity metric for each of the one or more human evaluators;
identifying a ranking from the evaluation from each of the one or more human evaluators;
weighing the ranking of each of the one or more human evaluators based on the updated fidelity metric thereof to generate a weighted ranking for the human evaluator;
obtaining an integrated ranking for the answer based on the weighted ranking of each of the one or more human evaluators; and
determining the cumulative ranking of the answer based on the existing ranking and the integrated ranking for the answer.

19. The system of claim 18, wherein the updating the fidelity attribute of the machine expert comprises:
retrieving an existing fidelity attribute associated with the machine expert;
modifying the existing fidelity attribute based on the cumulative ranking of the answer; and
generating an updated fidelity attribute based on the modified fidelity attribute for the machine expert.

20. The system of claim 15, further comprising:
extracting, from the feedback, information related to at least one of an alternative answer in place of the answer provided by one of the one or more human evaluators, an alternative reference relied on to derive the alterative answer, and an alternative source to access the alternative reference; and
modifying an archive storing references from different sources based on the alternative reference and the alternative source.
